(19) United States
(12) Patent Application Publication
(10) Pub. No.: US 2014/0046786 A1
(43) Pub. Date: Feb. 13, 2014

(54) Mobile Merchant POS Processing System, Point-of-Sale App, Analytical Methods, and Systems and Methods for Implementing the Same

(71) Applicants: Hooman MAZAHERI, Reading (GB); Christopher Alan CHADWICK, Wokingham (GB); Mohd Azham Azhari WASI, London (GB)

(72) Inventors: Hooman MAZAHERI, Reading (GB); Christopher Alan CHADWICK, Wokingham (GB); Mohd Azham Azhari WASI, London (GB)

(73) Assignee: BANCTEC LIMITED, Slough (GB)

(21) Appl. No.: 13/616,817

(22) Filed: Sep. 14, 2012

(30) Foreign Application Priority Data
Aug. 13, 2012 (GB) 1214436.6

(51) Int. Cl. G06Q 20/40; G06Q 20/20

(52) U.S. Cl. 705/18

(57) ABSTRACT

Disclosed herein are payment systems and methods for accepting and reconciling consumer credit or debit account transactions between merchants and consumers. The described systems and methods include merchant-employee POS application software that can be downloaded onto portable communication devices such that portable POS terminals can be easily deployed into a mobile sales network. Further disclosed are security techniques that can be employed within this system analytics systems and methods for gleaning useful data from the aggregation of multiple merchant employee POS terminal sales data.

### CROSS-REFERENCE TO RELATED APPLICATIONS

The present application claims priority to Great Britian Pat. App. Ser. No. 1214436.6, filed Aug. 13, 2012, and entitled “Mobile Merchant POS Processing System, Point-of-Sale App, Analytical Methods, and Systems and Methods for Implementing the Same”, incorporating herein by reference.

### TECHNICAL FIELD

The present disclosure relates generally to providing a portable POS application enabling small merchants to establish mobile credit card transactions in support of mobile sales.

### BACKGROUND

In known point-of-sale (POS) systems, a merchant will procure a POS terminal for processing credit and debit transactions. As a part of that process, the merchant will work with a payment service provider and a POS terminal, which is typically a device a merchant will have next to the cash register, for receiving credit/debit card swipes, taps, or other mechanisms for receiving the credit card information.

Because of the need to avoid fraudulent POS transactions, the payment service provider performs a number of checks on the merchant information on behalf of a bank that is exposed to the fraud risk (an exposed bank) to confirm the merchant is legitimate and an acceptable credit risk. Thus, the payment service provider will often perform a credit check on the company and confirm it is a valid business at a certain physical address or addresses. Typically the confirmation that a business is at a certain physical address includes actually going to the physical facility to confirm that the business is at that certain address.

### SUMMARY

The present application establishes systems, methods, and rules for enabling small and mobile merchants to have mobile POS applications and/or a portable card reader and personal identity number (PIN) entry device on or associated with their personal digital computing or communication devices or communication services. The present application describes means by which a payment service provider acting on behalf of a credit card issuing and/or exposed bank, may evaluate a business risk of applying merchants, i.e. merchants applying to register for use of a POS system, and provide approvals and/or policies to be applied in clearing credit or debit transactions received from those merchants.

The first part of this process is described as the “application” process, which refers to the steps that are undertaken in order to receive a merchant account application and approve or deny the merchant account application. Activities like authentication of the merchant's identification, proof of the merchant's business and the like are performed as a part of the application process.

There is a further “on-boarding” process where the merchant account profiles and policies are established. It is as part of this process that rules or policies can be built in to or otherwise associated with a merchant profile. The rules may be based on a merchant category or a merchant price plan (i.e. a set of tariffs that the merchant will be subject to as part of the service). The on-boarding process may include actions like building a merchant's account profile, including the business name, company or trading entity address, and also things like setting high/low transaction limits, settlement period, and transaction processing fees. This list is not exhaustive.

In the presently described embodiments, the merchants are enabled to have mobile employees who will be out in the field selling products or services. Based on described authentication and validation methods known in the prior art, such merchants would not have had an opportunity to provide mobile credit/debit transaction authorization and acceptance using a POS terminal application, in conjunction with a PIN entry device, on their employees' or agents' mobile communications devices.

The presently described embodiments not only provide this ability for merchants to deploy mobile POS solutions with their mobile sales or service employees, but also provide for an unprecedented level of granular analytics for products sales and service activities across geographic regions, employee service activities, etc.

Further, for the payment service provider itself, there is a great opportunity to provide collective intelligence based on information gathered based on clearance transactions and application processing across all of the merchant banks and merchants for which it provides a service.

Further disclosed is the ability of the payment service provider to act as a “master merchant” for the multiple subscribing merchants. One problem that has existed heretofore in such master merchant setups is that in the statements issued to cardholders by the card company is that only the “master merchant” information was identified on the cardholders' credit card statements. As an example, consider an aggregator website for multiple merchants, where it is the aggregator who provides the platform through which multiple online merchants provide individual stores but where the aggregator handles the payment processing. The cardholder would not have had specific information about who they have purchased from or what they have purchased on their monthly card statements. In contrast, presently described embodiments provide for enriched clearance data to be provided by the payment service provider to be passed on with the transaction authorization information whereby the enriched transaction data (including, e.g., the actual merchant subscriber name) can be passed on to the ultimate card issuing bank. This enriched data can, for example, be provided on through the clearance network when the transaction is sent to a clearing bureau (if one is used), the payment service provider or the card issuer to get the approved/not approved answer for the transaction and any particular return codes.

The present system enables the merchant bank (the bank issuing the accounts to the selling merchants) to provide merchant portals such that merchants may administer their accounts, including the POS applications and portable devices described as a part of the present application. The merchant is able to self-serve and, depending on levels of authorization given to the merchant, the merchant may change the configuration and assignments of POS terminal devices and/or POS mobile device apps (applications). The merchant may also be enabled to view their account status and set up item sales codes, amounts, and descriptions for items to be sold through the POS applications and mobile terminals. The merchant may also review transaction histories and perform analytics on their sales. Exemplary analytics could be based on products and services provided, they can include time-based and geographic-based limitations.

Further disclosed in the present approach are systems and techniques for validating that a card transaction is being made from an authorized portable terminal and/or an authorized POS app running on a qualified user's (e.g. an authorized user) portable communications device. Thus, when (or as a preamble to) a transaction comes in from a portable terminal and POS application, encrypted or hashed identifications sent from the portable terminal or optionally from the POS application can be cross-checked against identifications stored in a database for security purposes. Thus, the portable terminal may have a Terminal ID (TID) that can be registered as associated with a merchant through the merchant application fulfillment process or at a later time (as the merchant account is updated).

### BRIEF DESCRIPTION OF THE DRAWINGS

FIG. 1 is an illustration of an exemplary system implementation according to the present application;

FIG. 2 is a flow diagram illustrating an exemplary new merchant application process in accordance with the present disclosure;

FIGS. 3A and 3B are illustrations of exemplary merchant data records for processing and use in methods described in the present application;

FIGS. 4A and 4B are illustrations of exemplary clearance processes in accordance with the system and method embodiments disclosed within the present application;

FIG. 5 is an illustration of an another exemplary system implementation according to the present application, this system implementation including an analytics system and method;

FIG. 6 is an illustration of an example analytics report that could be generated in accordance with the exemplary analytics system and method of FIG. 5; and

FIG. 7 is a flowchart describing an exemplary method of associating terminal IDs with portable POS terminals.

The present embodiments will now be described hereinafter with reference to the accompanying drawings, which form a part hereof, and which illustrate example embodiments which may be practiced. As used in the disclosures and the appended claims, the terms “embodiment” and “example embodiment” do not necessarily refer to a single embodiment, although it may, and various example embodiments may be readily combined and interchanged, without departing from the scope or spirit of the present embodiments. Furthermore, the terminology as used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

Although similar reference numbers may be used to refer to similar elements for convenience, it can be appreciated that each of the various example embodiments are considered to be distinct variations.

### DETAILED DESCRIPTION

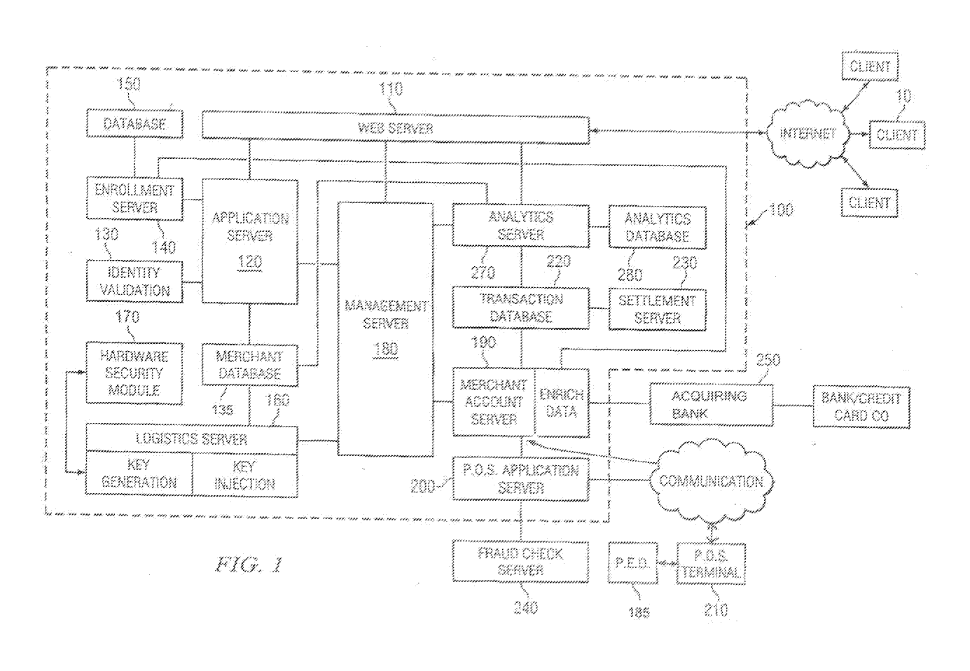

Illustrated in FIG. 1 is a system 100 provided for credit transactions by small and mobile merchants. A small merchant may be a sole trader or a trading entity having low annual revenues and/or only a few staff. As shown in FIG. 1, within the system 100 is a web server 110, which is arranged to provide a web interface to various client machines 10. The client machines may be mobile telephones in association with a web enabled device, smart phones, PDAs, portable computers or desktop computers. This list is not intended to be exhaustive or limiting. The web server 110 is operable among other things to receive merchant applications for new merchant accounts. The web server 110 connects to a merchant application server 120, which is responsible for the management of the new applications from merchants, and may be referred to herein as an application server. The merchant application server 120 receives through the web server 110 a merchant application from a client machine 10 and checks the identity of the applying merchant through an identity validation system 130. The identity validation system 130 may interface to such known services as Yellow Pages, credit rating companies, national registers of companies and other suitable resources available within an appropriate region or jurisdiction to perform its merchant identification analysis.

As a part of the application process, the merchant application server 120 may populate a merchant database 135 with merchant identification information such as the merchant name, merchant address, registered users such as named individuals that work at the merchant, and possible associations of such registered users with portable terminals through terminal IDs and the like. Also stored in the merchant database 135 may be items such as portable terminal identification numbers, telephone details such as telephone number and unique device identity data of telephones belonging to a registered user, and other possible information to help manage a merchant account associated with the particular merchant. For instance, the merchant database 135 may include details for access by personnel other than just employees such as service personnel associated with the merchant such as their accountant, attorneys, etc.

An enrollment server 140 is also involved in the application process described above. The enrollment server 140 is responsible for performing further analytics on the incoming merchant applications, and based upon the overall system's exposure to multiple different types and multiple different applications to provide an assessment of the creditworthiness and/or appropriate risk profile and settlement periods for a new merchant. In other words, this new system is operable to help classify merchant applications according to their respective risk and provide an unprecedented level of configuration for new merchant account setups. As a part of this process, a database 150 is provided (connected to the enrollment server 140) which maintains historical data concerning multiple new merchant applications in order to provide the appropriate dynamic “level of risk” assessment profiles. Database 150, in addition to containing multiple merchant application profiles, may also preferably contain multiple merchant histories in order to help assess the relative risk profiles for the new merchant applications. Thus, when a new merchant applies for enrollment into the system and service, the database 150 may be queried to see how creditworthy similar merchants have been, and this information may be used to modify the risk profile associated with the new merchant. “Similar” may involve an assessment of a merchant's trade, geographical location and size. Further as a part of the application process, for new merchants that have been accepted for use of the payment system, a logistic server 160 is provided to help establish the merchant's associated hardware for accepting credit or debit transactions through their personal POS App Terminals 210 and payment terminals 185 (sometimes referred to herein as a “PED” or secure portable electronic device).

The POS App Terminal 210 will be described further below, but specifically the terminal provides a means for interacting with a device that is referred to herein as a “PED” which is a secure portable electronic device for accepting payment using a credit card, debit card, prepaid card of the like and which is configured through the logistics server 160. The POS terminal 210 may run a graphical point of sale application such that items can be selected for sale and bills of sale generated. The logistic server 160 includes functionality for key generation and key injection into the PED by cooperating with a Hardware Security Module 170. The Hardware Security Module 170 is responsible for associating keys and terminal IDs with the portable electronic devices 185 that function as card payment terminals that are associated with the merchant.

The portable electronic device 185 and key association relationships can be stored in the merchant database 135 as indicated by the connection between the Logistic Server 160 and the merchant database 135. Each merchant may have several of these portable electronic devices 185 and so the merchant database 135 may include multiple associated portable device and key associations such that the later transactions can be cross-checked against the merchant database 135 to confirm that a certain portable device transaction is authorized to be applied against that merchant.

The merchant database 135 may also contain certain temporal and/or geographic limitations or data for tracking the appropriate transactions entered into by a merchant using the portable electronic devices 185. Monitoring this data may enable detection of inappropriate activity, either by the merchant or one of their employees. A good example is a hairdresser or other type of typical service merchant who would be expected to have transactions only during the day. The merchant database 135 may contain further data or policies around when and where transaction should be expected at the given time. Transactions occurring outside of the time range may point to staff moonlighting, theft of a device, the business being engaged in activities outside of its declared range of activities, and so on. And another possible approach is to have either a separate policy database or a security database associated with various merchants that would detail some of the expected transaction details for security purposes.

Focusing now on the processing side of this FIG. 1, a management server 180 is provided in order to facilitate overall communication between the various servers, databases and system elements shown in FIG. 1. The management server 180, for instance, may be responsible for communicating things like the device keys or device identities from the logistic server to the transaction database 220 or merchant account server 190 as will be described further below.

The management server 180 may also be responsible for providing communications from the web server 110 to the merchant account server 190 such that merchants can access their personal accounts and/or the card or payment transactions that they have processed. The merchant account server may be regarded as functioning as a “bureau”. The merchant account server 190 provides the merchant portal by which the merchants can manage their accounts. Once the merchant has been approved as part of the application process, the merchant establishes a merchant account on the system 100. This system 100 provides for a high level of personalization for each merchant by which the merchant can manage its particular end-product and end-service sales offerings through its portable POS systems. In particular, the merchant accounts described here operate through a handheld POS Terminal 210 which interacts with a point of sale application server 200. The present applicant has realized that an inexpensive and powerful point of sale terminal 210 could be provided by harnessing the computing power of smart phones and the like providing a POS interface by use of an application that would be implemented and installed on such Smartphones, Blackberrys, iPhones, Android devices, and other still-to-be-designed portable devices. Such Smart phones, Blackberrys, iPhones, Android devices, and other still-to-be-designed portable device operating systems are generally deficient at providing the security systems needed for chip and pin payments, but this functionality is provided in the presently described embodiment by the PED 185. Communication with the POS terminals 210 is typically through a mobile phone network, although the smartphones running the POS application may also connect through a Wi-Fi network connected to the internet but in any rate, the specific POS application would be running on the external devices (e.g. mobile phones outside of system 100) that the merchant's employees would typically use as they travel around to undertake individual credit card or debit card transactions with their customers or clients. The POS terminals 210 communications capabilities may include Bluetooth, NFC, or other type of communication protocol for communicating with the portable devices 185. As mentioned previously, the system 100 includes security features whereby the portable device identifiers are stored in the merchant database 135 such that transactions can be confirmed and authorized as coming from a legitimately associated portable device 185 to help prevent fraud. In particular, it is important to prevent a fraudulent user from processing a credit transaction back to themselves through an unauthorized portable device.

Further referring to the transaction processing side of FIG. 1, a transaction database 220 is provided for storing individual transactions that are entered into and received from POS terminals 210 through the POS application server 200. The merchant account server 190 manages the transaction database 220 to store individual transactions. At the end of each day, or at other appropriate times, a settlement server 230 is operable to provide clearance and settlement with the merchants such that the merchant can be told how much they are due and such that the merchant can receive the appropriate funds transfer or deposit for transactions that have become due to the merchant following expiry of the settlement period associated with the merchant.

Typically a merchant would not receive funds in their account on the day that a transaction occurred, but rather each transaction is subject to a settlement period of a few days according to the security policies and settlement policies that had been established for a particular merchant. For instance, a merchant might be on a 5-day settlement period such that once all of the appropriate credits and or debits had been entered into and cleared through the clearance process, their payments would relate to transactions that occurred five days earlier.

A fraud check server 240 is in communication with the POS application server 200. Each individual transaction is received from a POS terminal 210, and as mentioned before, the portable device ID for the terminal 210 is received and the POS application server 200 communicates by way of the management server 180 to confirm through the merchant database 135 that the portable device is correctly associated with the merchant (and optionally the appropriate employee of the merchant) attempting to process the transaction. If it is not, then various security approaches that can be taken to limit or prevent potentially fraudulent transactions. Further, the POS application server 200 is operable to communicate through the fraud check server 240 with various anti-fraud reporting services such as those maintained by individual card issuers, and/or third-party services.

The merchant account server 190, once its transactions have been decrypted and cleared through the POS application server 200 and through the fraud check server 240, is operable to enrich the data for further sending to a financial institution such as an acquiring bank server 250 that may further communicate with other banks or a card processor 255. When referring to this enrichment, what is meant is that the “merchant” for purposes of interfacing with the bank itself would be the system 100 described here. Thus once there is a purchaser that has purchased goods or services from a merchant, and the merchant has registered with the system 100, it is the system 100 which acts as a master merchant and it is the master merchant that undertakes the main transactions with the credit card processor as a proxy for the actual merchant. The enrichment data is used to specifically identify the actual merchant that the customer or consumer is dealing with such that more specific data can be provided on the customers or consumer's credit card or bank card statements.

There may be opportunities to add other data as a part of this enrichment that would help tracking and/or monitoring the transaction, possibly including the access of individual transaction data by the customers. It may also be possible for the merchant to get specific data or maintain specific data on their website or on their merchant portal that is associated with the system 100. This enrichment is instantiated in the merchant account server's 190 communication with the acquiring bank server 250 and can be done in real-time such that no further intervention of the system is needed at a later time. The bank server 250 is also responsible for providing in real time a transaction approval back to the merchant account server 190. It is only upon receipt of that approval from the bureau server that the transaction will proceed and would be allowed through the POS terminal 210. As a consequence, the merchant account server 190 maintains a current and valid set of transaction data without the need for subsequent processing or secondary processing.

Further shown in FIG. 1 is an analytics server 270 which is operable to provide a whole new level of a granular analytics that is useful to customers of the system 100. More specifically, the analytics server 270 is in communication with the analytics database 280, which can keep historical data of multiple transactions across multiple merchants, specifically including data broken down along geographic areas, the types of merchants, the values of transactions, the values of transactions in certain merchant category codes, the values of transactions in certain merchant category codes in different geographic regions, and combinations of these and other data. These applicable metrics can then be provided to third parties for a fee, and to subscriber merchants as a part of their normal subscriptions or as a separate for-fee service. Because of the very granular level of data provided in the present application, the systems and methods described herein therefore provide an unprecedented level of geographic and transactional data granularity not heretofore known in merchant analytics.

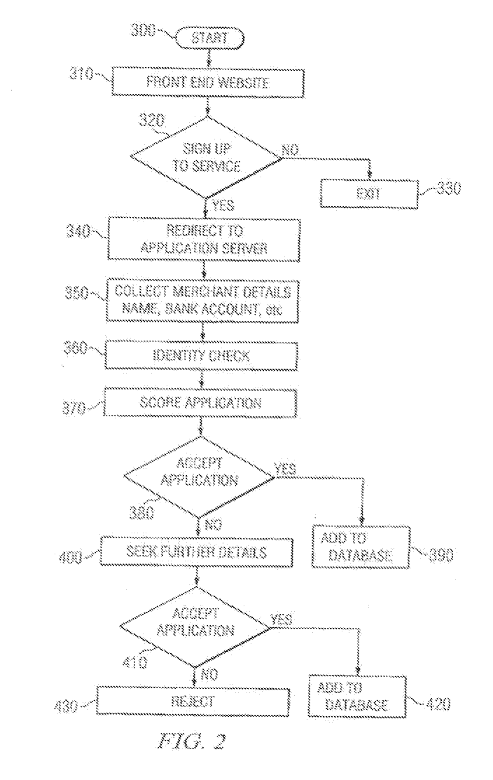

The merchant enrollment process will now be described with reference to FIG. 2. The process starts at step 300 where a merchant enters via the web interface hosted by the web server 110. Optionally, the merchant may first be provided to a proxy server operated by, for example, a credit card provider, which may for example be a visa front-end website 310. The website may provide the option to sign up to a merchant service at step 320. If the merchant decides to proceed to enrollment, control passes to step 340 otherwise it passes to step 330 where the process is exited.

From step 340, the merchant is redirected to the application server 120, which collects prescribed merchant details, for example merchant name, merchant address, bank account details, and other information which the credit account company may require as part of its enrollment process. Details may be filled on a form at step 350.

Once sufficient and mandatory details as prescribed by the acquiring bank or card processor have been collected, control may pass to step 360 where initial identity checks are performed using the identity validation server 130. Steps may include checking that the company has the phone number which has been registered to it, that it exists at the given address, that in the case of sole traders they appear on appropriate electrical or a tax register and so on. From step 360 control passes to step 370 where the application as combined with the augmented identity check information is then subjected to a scoring process in order to rate the merit of the trader's application.

Scoring of the application may include metrics which relate not just to the individual or trader per se, but to their class of trader. Data may be sought from enrollment server 140, which contains information about classes of trader in order to dynamically vary the application score. As an example, the enrollment server 140 may determine that florist in the North of England tended to trade for only six months whereas florists in the South of England tend to trade for two years. This information may be passed to the application process in order to vary, for example, the user's settlement period, credit card fees applied to other payments as part of the service provided to them, or other features of the service.

From step 370, control passes to step 380 where the application is reviewed to see whether it is accepted or not. The acceptance step may include multiple thresholds, if a user's score optionally as dynamically modified, exceeds a first acceptance threshold then the application is accepted and they are added to the merchant database 135 at step 390. If, however, the score is below a first threshold, but above a second threshold control may be passed to step 400 where further details are sought in order that enhanced assessment of the risk profile presented by a merchant can be made. From step 400 control passes to step 410 where the merchant's application is now scored once more, and if they are successful they are added to the merchant database 135 at step 420 otherwise they are rejected at step 430. In some instances step 380 may be able to reject an application without invoking steps 400 and 410.

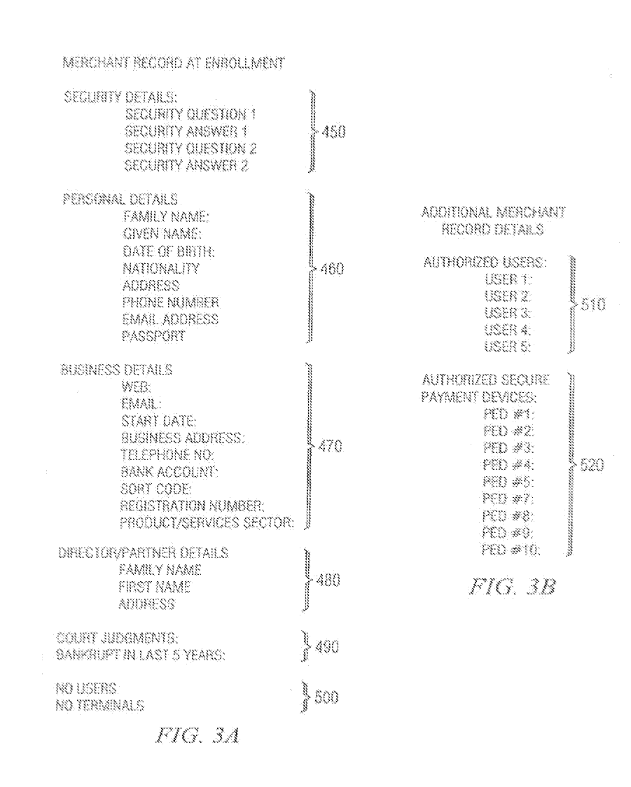

FIGS. 3A and 3B illustrate an example of a merchant record at enrollment. This is a data record that will be stored in the merchant Database 130, which includes details stored by a user operating through a client machine 10 through the web server 110. This would occur at the time of a new merchant application taking place to the application server 120. FIG. 3A specifically shows:—specific security details relating to user sign on 450; Personal details relating to the administrative user 460; Business details relating to the merchant including the business web address, e-mail address, business telephone number, bank account and the like as well as the product services sector particularly identified by the Merchant Category Code (MCC). This list is not exhaustive and further items may be added or existing ones removed from the list.

FIG. 3A further shows director-partner details for the business 480, historical court judgments, bankruptcies and the like 490, and finally it includes the selection of the number of users and terminals 500. While most of these details would have been entered into by the user's configuration through the client interface and through the portal through the web server 110, at least some of these may be gained through other sources such as the identify validation process 130. Again, all of these details may be stored in a merchant record associated with the particular merchant in the merchant database 135.

Shown in FIG. 3B are additional merchant record details. These details include specific fields for additional authorized users of the merchant. In particular, these users could be administrators for the merchant, accountants for the merchant, and/or authorized sales persons for the merchant. These additional users are listed in and illustrated under element 510 of FIG. 3B. FIG. 3B also illustrates a list 520 of the authorized secured payment devices 185 associated with the merchant. These authorized payment devices 185 are used for security purposes to ensure that the transactions requested through the POS terminals 210 are being transacted through secured payment devices that are authorized for a particular merchant. This can help prevent fraud against the merchant or other parties. In this example, ten separate secure payment devices are shown, and it should be noted that these are not generally input by the users themselves, but instead are populated within a merchant record through the logistic server 180, which generates the applicable identification codes to be associated with the various secured payment devices belonging to the merchant.

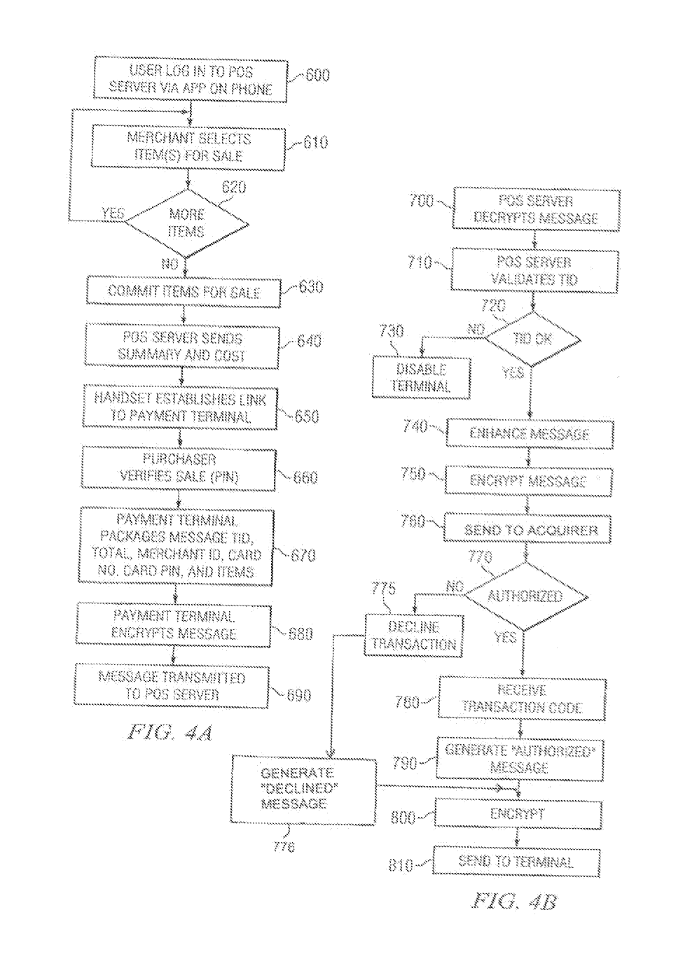

An illustrative transaction will now be described with respect to FIGS. 4A and 4B. These following method steps are carried out by computer instructions run by the POS application server 200 and/or the user's POS terminal 210 running computer instructions stored on computer-readable media associated with the respective server and terminal. The process commences at step 600 where a merchant logs into the POS application server 200 using a portable communications device such as a smartphone running a portal application and which functions as the POS terminal 210. At this point the PED may be involved in generating a secure logon message or code to authenticate with the server 200. The user may also have needed to have logged in to local security provided on the portable electronic device. Having logged into the POS application server 200, the merchant is able to select items for sale at step 610. From there, control passes to step 620 where the merchant is offered the opportunity to add more items for sale. If the merchant indicates that more items are to be added then control returns to step 610, whereas if the merchant indicates that no more items are to be added then control passes to step 630 where the items are committed for sale. From then control passes to step 640 where the POS application server 200, in this example, sends a summary of the items that are being sold together with a cost back to the POS terminal 210. This gives a purchaser an opportunity to review their purchases before proceeding with a payment part of the transaction.

The POS terminal, such as a suitable smartphone then establishes a communications link to the payment terminal 185 at step 650. Such a link may be established by any appropriate communications technology, for example, Bluetooth or Wi-Fi. An indication of the items for sale and/or a transaction value is then passed to the terminal (PED) 185, and the purchaser or customer is then asked to verify the sale. Verification may include any appropriate method, such as entering a Personal Identification Number (PIN) or by bringing a suitably enabled credit card or debit card into proximity with a contactless reading device.

Once the purchaser has verified the sale, control passes to step 670 where the payment portable terminal 185 packages a message for presentation to the POS application server 200. The message includes the payment terminal identity (TID) a total for the transaction, a merchant ID, which may have been manually entered by the merchant or passed automatically from the POS application server 200, the purchaser's credit card number, the credit card PIN if appropriate and optionally a list of items that have been purchased. From there control passes to step 680 where the payment terminal encrypts the message using a session or other appropriate key. The message is then transmitted to the POS application server 200, or optionally to the merchant account server 190, at step 690 using the merchant's mobile phone as a communications conduit.

The POS application server 200 receives the message and decrypts it at step 700 using a session key. It then proceeds to extract the terminal identity from the message at step 710 to validate whether the terminal identity is correct and that the terminal has not been flagged as being in the hands of an unauthorized user. Control then passes to step 720, where a check is made to see if the terminal identity is okay and the terminal is authorized for use.

If a terminal has been flagged as suspect, then control is passed to step 730 where a message is sent to disable the terminal 185 and to cause the terminal or the POS application to generate a transaction declined message. If the terminal 185 passes the terminal identity test step 720 then control passes to step 740 where the message is enhanced to add information, which is useful for the customer, such as the merchant name or other merchant and/or user-defined information. Control then passes to step 750 where the message is encrypted and is then transmitted to a suitable financial institution, such as a card processor or an acquiring bank, and it executes an algorithm to decide whether or not the transaction is to be approved at step 770. Alternatively if a further party may tasked with making the accept/decline decision. If the transaction is not approved then control passes to step 775 where the transaction is declined, and a “declined” message is generated as step 776 for sending to the terminal at step 810. However, if the transaction is approved, then control passes to step 780 in which a transaction code is transmitted to the POS application server 200. The POS application server 200 then proceeds to generate an “authorized” message at step 790 and to encrypt it at step 800 before sending it to the POS terminal at step 810.

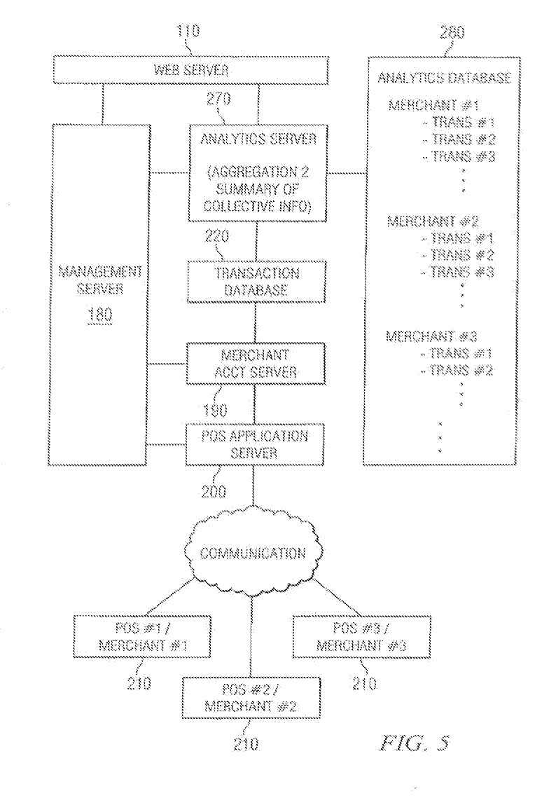

FIG. 5 is an abbreviated version of FIG. 1 in which there is illustrated a portion of the system in which transaction analytics are employed with the analytics database 280 that is provided as shown in FIG. 1. As previously discussed, the multiple transactions will come through the communication interface of the POS application server 200. These multiple transactions can be from, e.g., merchant #1, merchant #2, and merchant #3. Furthermore, these transactions will come from multiple merchants as the services are aggregated within the overall system 100 for many, many merchant accounts. By having this specific transaction information for all of these different merchants, the system 100 is able to get granular information about the types of transactions that are occurring broadly throughout the market, with specific information able to be broken down according to geographic areas among other things, including such as the Merchant Category Codes (MCCs). This information may be made available to a merchant via the merchant portal.

As reflected in the analytics database 280, there are multiple transactions stored historically in the analytics database 280 by the analytics server 270. In other words, the analytic server 270 provides a historical view of the various transactions that are received in the transaction database 220, but where the transaction database 220 provides information and data entries for things like clearance, the analytic server provides a historical view of the overall trends. So for example, and referring as an additional example to FIG. 6, one could develop a historical view of the sales trends in various geographic marketplaces such as shown in the various British and Irish areas shown on this figure.

The management server 180 helps coordinate the communication between the various servers and databases and furthermore may provide an interface to external services that might subscribe to the analytics the system provided and described here.

The analytics information from one sector may provide predictive information for another sector, and the analytics database may be data mined to establish such links, and then the links used as an ongoing indicator for assessing the risk of accepting new merchants. For example, a decline in the number of people engaging the services of motorcycle instructors in the UK was a precursor to difficult trading conditions for motorcycle dealers a few years later. Other such links may be identified, and association that hold true in one country or trading area may provide useful data for assessing risks in another country which may be at a different point in an economic cycle.

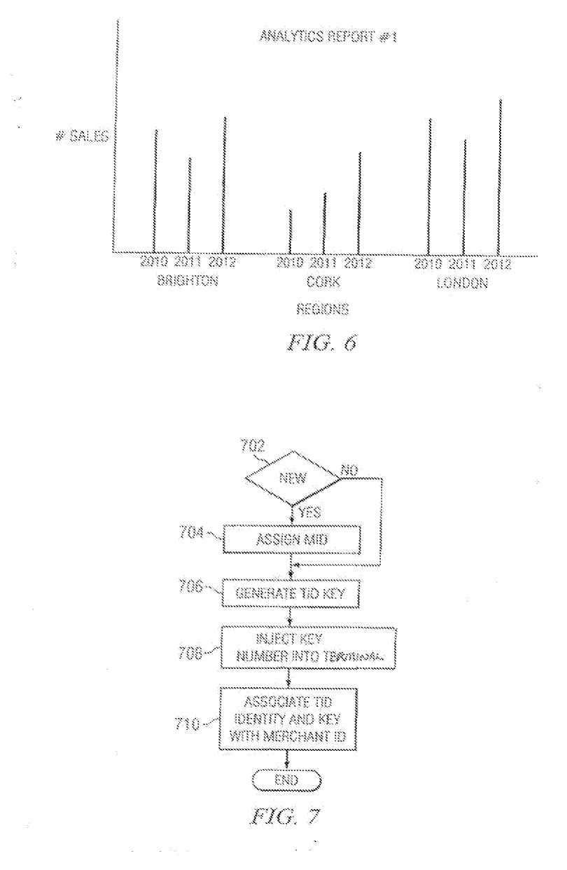

Referring now to FIG. 7, illustrated here is a process for the generation of new terminal IDs, as may occur in the case of new merchants being assigned new terminal IDs or new portable devices being assigned to the merchant. These following method steps are carried out by computer instructions run by the logistics server 170 and/or the user's POS terminal 210 running computer instructions stored on computer-readable media associated with the respective server and terminal Referring back to FIG. 3B, field 520 that was previously identified as relating to the number of portable devices assigned to the new merchant and the terminal IDs that are assigned. In the case of an updated maintenance field record additional terminal IDs may at times be required as will now be discussed.

With specific reference to FIG. 7, there shown a decision block 702 that determines if the merchant is a new merchant in which case at step 704, if the merchant is new, a specific merchant ID is generated and stored in the merchant database 135 and associated with the merchant. The merchant ID, MID, is directly injected into the merchant database 135 by the logistics server 160 as opposed to the user data entry that's been previously described. From this step 704, the logistics server 160 proceeds to generate the terminal IDs and encryption key for each of the number of portable devices being requested with respect to the new user or users at step 706. The same step 706 is also used in the case of an account maintenance when new terminal IDs are being requested or when new portable devices are being requested.

Still referring to FIG. 7, at step 708, the hardware security module 170 takes the encryption keys that were generated by the logistic server 160 and injects those encryption keys and a terminal identity into the portable devices 185 to prepare them for dispatch to the merchant. Furthermore, at step 710 the new keys and terminal identity that have been generated are also stored as approved terminal IDs associated with the particular merchant in the merchant database 130. Consequently the merchant record in the merchant database 135 is updated to include the full list of terminal IDs associated with the merchant and that would be occurring at step 710. The encryption keys may also be stored in the merchant record, or may be stored in another database (such as within the logistics database) and accessed indirectly via the provision of the terminal ID and a suitable security token from a server or database wishing to have access to the terminal's key

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

For example, as referred to herein, a machine or engine may be a virtual machine, computer, node, instance, host, or machine in a networked computing environment. Also as referred to herein, a networked computing environment is a collection of machines connected by communication channels that facilitate communications between machines and allow for machines to share resources. Network may also refer to a communication medium between processes on the same machine. Also as referred to herein, a server is a machine deployed to execute a program operating as a socket listener and may include software instances.

In all descriptions of “servers” or other computing devices herein, whether or not the illustrations of those servers or other computing devices similarly show a server-like illustration in the figures, it should be understood that any such described servers or computing devices will similarly perform their described functions in accordance with computer-readable instructions stored on a computer-readable media that are connected thereto.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field.

Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure.

Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A payment service system for accepting and reconciling consumer credit or debit account transactions between merchants and consumers, the payment service system comprising:
a merchant database comprising a plurality of merchant records, the merchant records each comprising a merchant ID field and at least one terminal ID field of an approved merchant;
a payment terminal identifiable by a terminal ID; and
a Point-Of-Sale server configurable to communicate with the merchant database and the payment terminal;
wherein the Point-Of-Sale server is operable to receive a transaction request from the payment terminal, the transaction request comprising the terminal ID, and
wherein the Point-Of-Sale server further determines whether the transaction request originated from an assigned payment terminal by checking the received terminal ID against the one or more terminal ID fields in an associated merchant record in the merchant database.

2. The payment service system of claim 1, further comprising a logistics server in communication with the merchant database, the logistics server operable upon notification of approval of a new merchant to assign a terminal ID to each payment terminal to be associated with the new merchant and to store the assigned terminal IDs in the terminal ID fields in the merchant record associated with the new merchant in the merchant database.

3. The payment service system of claim 1, wherein the payment terminal comprises a merchant portable communication device having installed therein a POS terminal application, the merchant portable communication device configurable to perform a functionality of the payment terminal and to be identifiable by one or more of the terminal IDs stored in the merchant record associated with the approved merchant.

4. The payment service system of claim 1, wherein the requested transaction is blocked when one or more of the following occurs:
(a) the received terminal ID does not match one of the stored terminal IDs in the merchant record;
(b) the transaction request is received on a date and a time in which the payment terminal is not expected to be used;
(c) a geographical position of the payment terminal sending the transaction request is not within an expected geographical region of use for the payment terminal; and
(d) an instruction is issued by a merchant interface operable to disable the payment terminal.

5. The payment service system of claim 3, wherein the POS terminal application installed in the merchant portable communication device is configurable to identify goods and/or services offered by the merchant, and wherein the POS terminal application is operable to generate a bill of sale for one or more of the goods and/or services of the requested transaction, and wherein the POS terminal application provides one or more of the cost and the one or more goods and/or services of the requested transaction to the Point-Of-Sale server.

6. The payment service system of claim 1, wherein the transaction request further comprises at least one of: a merchant name, customer name, customer address, employee name, a POS application identifier, time of transaction, date of transaction, geographical position of the payment terminal sending the transaction request, and the goods sold and/or services of the transaction request.

7. The payment service system of claim 1, further comprising a transaction database in communication with the Point-Of-Sale server operable to store the requested transactions, an analytics database in communication with the Point-Of-Sale server to store historical transactions conducted through the payment terminals of the approved merchants, and an analytics server in communication with the analytics database, the analytics server operable to analyze the historical transaction data compiled from the payment terminals of the approved merchants.

8. The payment service system of claim 7, wherein the analytics server is configurable to deliver reports for presentation via a presentation interface, the reports including trend data relation regarding the transaction request.

9. The payment service system of claim 8, wherein the analytics server is configurable to identify anomalies in performance of approved merchants compared to similar businesses, and to issue an alert when such an anomaly exceeds a predetermined threshold.

10. The payment service system of claim 1, further comprising a master merchant and one or more merchants, wherein the master merchant aggregates transactions on behalf of the one or more merchants and interacts with a bank or card processor for the transactions of the one or more merchants.

11. The payment service system of claim 10, wherein the master merchant transfers transaction data to a bureau service of the bank or card processor, and the master merchant enriches the data to add information regarding the merchant involved in the transaction.

12. The payment service system of claim 11, wherein the enriched data includes at least one of time and position information of the transaction.

13. The payment service system of claim 12, wherein the enriched data includes at least one of a merchant business identifier, merchant location, location of the sale, consumer information, time of the sale, value of the sale, identification of products sold, identification of services sold, identification of the mobile merchant communication device, identification of a portable payment terminal used to undertake the transaction.

14. A method of accepting consumer credit or debit transactions between merchants and consumers, the method comprising:
storing a merchant record for an approved merchant in a merchant database, the merchant record comprising one or more terminal identifiers;
identifying a payment terminal using a terminal identifier;
configuring a point of sale server to communicate with the merchant database and the payment terminal;
receiving, at the point of sale server, a transaction request from the payment terminal comprising the terminal identifier; and
determining whether the transaction request originated from an assigned payment terminal of an approved merchant by checking the received terminal identifier against the one or more terminal identifiers in the merchant record of the approved merchant.

15. The method of claim 14, further comprising assigning a terminal identifier to each payment terminal to be associated with a new approved merchant, and further comprising storing the assigned terminal identifiers in the merchant record associated with the new merchant in the merchant database.

16. The method of claim 14, wherein the payment terminal comprises a merchant portable communication device having installed therein a POS terminal application, the merchant portable communication device configurable to perform a functionality of the payment terminal and to be identifiable by one or more of the terminal identifiers stored in the merchant record associated with the approved merchant.

17. The method of claim 14, wherein the requested transaction is blocked when one or more of the following occurs:
(a) the received terminal ID does not match one of the stored terminal IDs in the merchant record;
(b) the transaction request is received on a date and a time in which the payment terminal is not expected to be used;
(c) a geographical position of the payment terminal sending the transaction request is not within an expected geographical region of use for the payment terminal; and
(d) an instruction is issued by a merchant interface operable to disable the payment terminal.

18. The method of claim 16, wherein the POS terminal application installed in the merchant portable communication device is configurable to identify goods and/or services offered by the merchant, and wherein the POS terminal application is operable to generate a bill of sale for one or more of the goods and/or services of the requested transaction, and wherein the POS terminal application provides one or more of the cost and the one or more goods and/or services of the requested transaction to the Point-Of-Sale server.

19. The method of claim 14, further comprising assessing a risk of accepting an applying merchant, the assessing comprising:
receiving details about the applying merchant, the details including at least one of business type, location, trading name, ownership and age of business;
querying an enrollment database which stores similar information for a plurality of businesses; and
extracting from the enrollment database information for businesses having similar or related attributes to the business of the applying merchant, and using said information to provide a risk assessment in respect of the applying merchant.

20. The method of claim 14, further comprising providing a master merchant and one or more merchants, wherein the one or more merchants send information for transactions of the one or more merchants to the master merchant using a mobile communications device running a point of sale application, wherein the transaction information is received by a point of sale server, wherein the master merchant communicates the transactions of the one or more merchants to a bank or card processor, and wherein the master merchant arranges for merchant accounts to be credited.

21. The method of claim 20, wherein the master merchant augments the transaction information communicated to the bank or card processor with one or more of the merchants name, customer name, location of the sale, merchant business sector identifier, merchant home or base location, time of sale, value of sale, identification of products sold, identification of services sold, identification of merchant mobile communications device, and identification of payment terminal used.

22. A payment service system for accepting and reconciling consumer credit or debit account transactions between merchants and consumers, the payment service system comprising:
a web server connected to the internet and operable to provide a new merchant application interface through which applying merchants can apply to be an approved merchant, the approved merchant authorized to receive consumer credit or debit transactions through the payment service system;
an application server for receiving new merchant applications from the web server, the application server further operable to perform identity validation of the applying merchant;
an enrollment server operable to dynamically perform assessments of new merchant applications, the enrollment server in communication with the application server to acquire characteristics regarding the new merchant application and dynamically provide comparative metrics of the applying merchant relative to dynamically updated historical data; and
an enrollment database in communication with the enrollment server, wherein the enrollment server is operable to store data regarding new merchant applications, provide dynamically updated historical data, and dynamically update historical data against characteristics of new merchant applications;
wherein the enrollment server is operable to communicate with the merchant database; and
wherein the enrollment server is further operable to update a policy in the merchant record of an approved new merchant in accordance with the dynamic evaluation of that accepted new merchant.
